(19) United States
(12) Patent Application Publication
(10) Pub. No.: US 2009/0045186 A1
(43) Pub. Date: Feb. 19, 2009

(54) Energy-saving cooker

(76) Inventor: Ming-Shih Chang, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 11/889,782

(22) Filed: Aug. 16, 2007

(51) Int. Cl. F27D 23/00; A47J 27/00

(52) U.S. Cl. 219/439; 219/428; 220/573.1

(57) ABSTRACT

The present invention is to provide an energy-saving cooker comprises an outer pot (1), a heating element (2) in the outer pot, an inner pot (3) is able to position into the outer pot (1), a thermal storage block (4) inside a bottom of the inner pot (3). The thermal storage block (4) and heating element (2) are disposed between inner and outer pot. There are two embodiments to heat up foods by inner pot (3). A heating element (2) inside the outer pot (1) can heat up inner pot (3) and thermal storage block (4) directly. An inner pot (3) and thermal storage (4) heated up by external heat source and then moved and placed into outer pot (1) inside.

### FIELD OF THE INVENTION

The present invention relates to a cooker is able to heat up inner pot continuously after the external heat source and electric power shut down.

### DESCRIPTION OF THE PRIOR ARTS

Conventional thermal cookers as U.S. Pat. No. 6,263,787 entitled “thermal cooker” to Rong-Yuan Tseng on Jul. 24, 2001 disclosed, it includes an outer pot and an inner pot positioned in the outer pot, several L-shaped hook plates disposed along a lateral bottom of the inner pot, a thermal storage ring and the L-shaped hook plates fixed by screws but remain a small gap between a bottom of the inner pot and the thermal storage ring where a thermal power of the thermal storage ring does not transmit to the inner pot directly. When the inner pot is removed from heating source and positioned inside the outer pot, food inside the inner pot still can be heated by a thermal power from the thermal storage ring continuously.

As discussed above, an inner pot must be heated up by external thermal source and let thermal storage ring turn hot, after that removed the heated inner pot with thermal storage ring from the external thermal source to the outer pot. In process of removing, it must be cautioned to prevent burning from the heated thermal storage ring. Next, inside the outer pot, there has no heating element. Therefore, the purpose of this invention is how to keep warm and boil in the outer pot, which is insulated from external thermal source.

In additional, the inner pot can be heated up by an external thermal source, for example, a gas cooker, then put the inner pot inside an outer pot.

### SUMMARY OF THE INVENTION

Point against aforesaid problems, the present invention is to provide an energy-saving cooker comprising: an outer pot (1); a heating element (2) disposed below a bottom of the outer pot; an inner pot can be positioned inside the outer pot, and a thermal storage block (4) for continuously warm up the inner pot is coupled to a bottom of the inner pot (3).

An energy-saving cooker as mentioned above, the thermal storage block (4) has a cut-out disk with spiral-shaped trough (41) formed through is corresponding to the heating element (2), the disk (41) has three fasteners (42) protruded out and projected upward are open widely enough as a tripod disposed inside the outer pot, whereby the heating element (2) fit in the cut-out disk (41) is disposed below the bottom of inner pot, further in contact with a plateau surface of the thermal storage block (4).

An energy-saving cooker as mentioned above, the thermal storage block (4) has the tripod-looked fasteners (42) coupled to grooves (31) at the lateral bottom of the inner pot (3), a gap is kept between the bottom of inner pot (3) and the thermal storage block (4), whereby the inner pot (3) is able to position on top of the heating element (2) of the outer pot (1).

An energy-saving cooker as mentioned above, a heating element (2) consists of heating filaments can set heating time and heated temperature, after electrification turns electricity into hot, the heating element supported by a tripod (21) to keep a gap to a bottom surface inside the outer pot (1).

An energy-saving cooker as mentioned above, the fasteners (42) are protruded out from a circumference of the thermal storage block (4), each of the fastener (42) is equipped with an upright mounting plate (43) axially projected upward, each of the upright mounting plate (43) is further equipped with a hook (44) at a distal end, the hook is convex in shape and faces inward; the grooves (31) is composed of a longitudinal groove (32), and a transversal groove (33) in communication with the longitudinal groove (32); the hook (44) can be guided from the longitudinal groove (32) and then moved into the transversal groove (33).

An energy-saving cooker as mentioned above, the groove (31) is L-shaped.

An energy-saving cooker as mentioned above, the groove (31) is T-shaped.

An energy-saving cooker as mentioned above, the groove (31) is circular in shape, where the transversal groove (33) surrounds the lateral bottom of the inner pot (3).

An energy-saving cooker as mentioned above, a distal end of the longitudinal groove (32) joined to the transversal groove, where a projection (34) projected upward for preventing the hook (44) from being guided out in reverse direction.

### BRIEF DESCRIPTION OF DRAWINGS OF THE INVENTION

FIG. 1: an exploded view of the first embodiment of the present invention.

FIG. 2: a cross-sectional view of FIG. 1 after assembling.

FIG. 3: an exploded view of an alternative embodiment of the first embodiment of the present invention.

FIG. 4: a cross-sectional view of FIG. 3 after assembling.

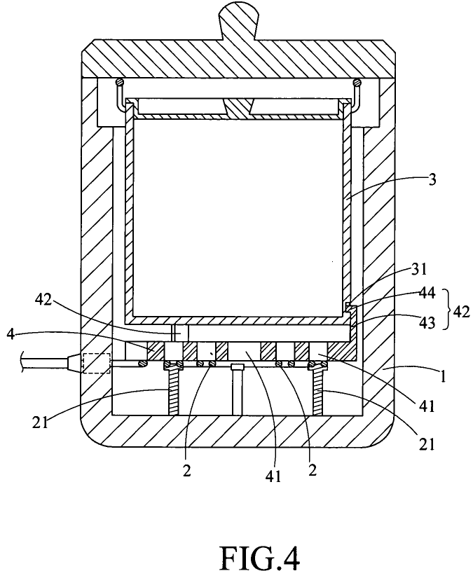

FIG. 5: a schematic view of the second embodiment of the present invention.

FIG. 6: a schematic view of the third embodiment of the present invention.

### DETAILED DESCRIPTION OF THE PREFERRED EMBODIMENTS OF THE INVENTION

Detailed description is described in detail according to the appended drawings hereinafter.

### First Embodiment

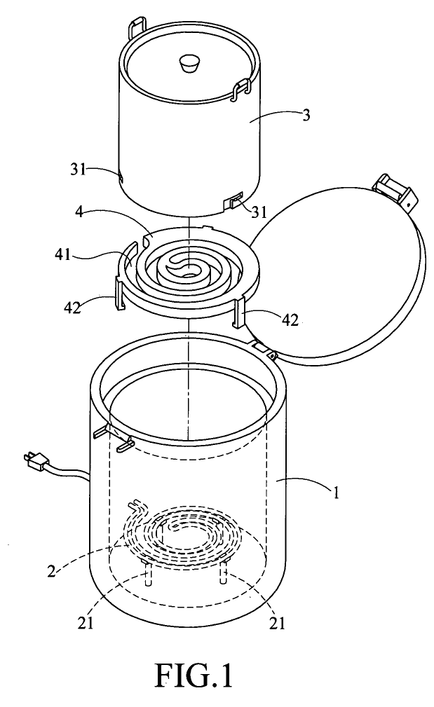

As shown in FIG. 1, an energy-saving cooker includes an outer pot (1), a heating element (2) disposed inside the outer pot, an inner pot (3) can be equipped into the outer pot (1), a thermal storage block (4) coupled to a bottom of the inner pot (3).

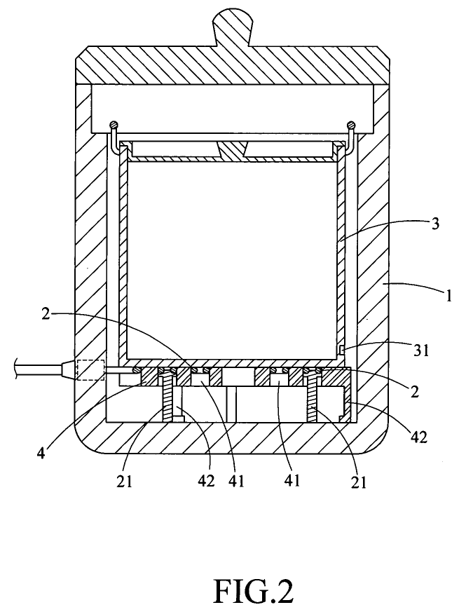

As mentioned above, the thermal storage block (4) is a cut-out disk, which has a spiral-shaped trough (41). Three fasteners (42) are protruded out from a circumference of the disk being projected downward and being opened wide enough as a tripod disposed inside the outer pot (1). Where the heating element (2) is corresponding to and fit in the spiral-shaped trough (41), the heating element (2) is therefore in contact with the thermal storage block (4), furthermore is in contact with the bottom of the inner pot (3), which is disposed above a plateau surface of the thermal storage block (4). (as shown in FIG. 2) When a heating element (2) starts heating up, thermal energy can be transmitted to the thermal storage block (4) and the inner pot (3) directly. Accordingly, the inner pot (3) may not necessary to heat up by external thermal source, for example, a gas cooker. In other words, the present invention is different from the conventional cookers whose inner pot, thermal storage block must be directly heated up by external thermal source and then removed inside outer pot, to continue heating up. In contrast, the present invention places the inner pot (3) and the thermal storage block (4) into the outer pot (1) directly where the heating element is directly contact with the bottom of the inner pot (3) and the thermal storage block (4). With the electrified heating element (2), the bottom of the inner pot (3) and the thermal storage block (4) can be heated up simultaneously. Moreover, after a heating element (20) is not electrified and stops working (stop heating up), the thermal storage block (4) is continuously heating up the inner pot (3). The heating element (2) can be equipped with a spiral-shaped filament (tube), which is able to set up cooking time, temperature to reduce power consumption. For instance, the heating element (2) is used to cook food inside the inner pot (3) required, at least, 40 minutes. But after adding a thermal storage block (4) to the bottom of inner pot (3), where thermal storage block (4) continues to heat up, thereby saves time for heating element (2) heats up the food up to 20˜30 minutes.

### Second Embodiment

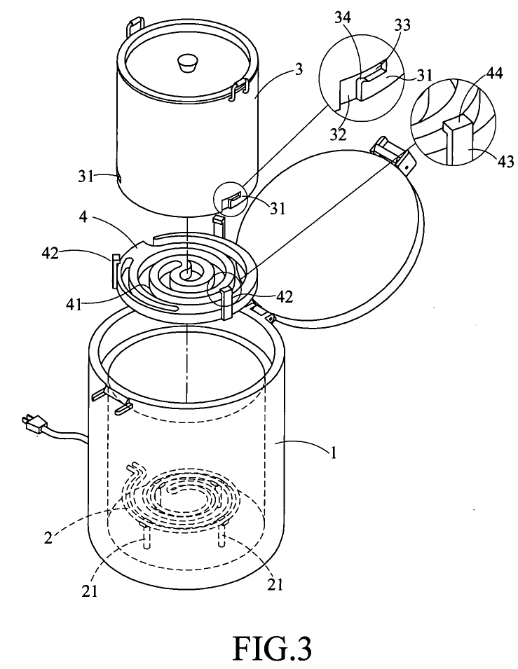

Next, as shown in FIG. 3, a thermal storage block (4) is coupled with a bottom of the inner pot (3) by grooves (31) formed along a lateral bottom of the inner pot coupled to three fasteners (42), a gap kept between the bottom of the inner pot (3) and the thermal storage block (4). When the power shut down or necessary to heat up by external heat source, it facilitates continuous heating process; namely, heats up the inner pot (3) and the thermal storage block (4) on an external thermal source, for example, a gas cooker, and then removes them from the gas cooker, puts them into the outer pot (1). Therefore, conventional heating up method with external thermal source is still available for cooking food by a cooker of the present invention. Said thermal storage block (4) is the same as depicted in FIG. 1, but the thermal storage block (4) of this embodiment is rotated 180 degrees to differ from the same of FIG. 1, after rotation, fasteners (42) must be projected upward to couple to the inner pot (3). Furthermore, location of the cut out disc (41) is not necessary corresponding to and fit in the heating element (2). The thermal storage block (4) is substantially held by the heating element (2) inside the outer pot (1). While the heating element (2) is substantially held by a tripod (21) which endures weight from the thermal storage block (4) and the inner pot (3).

### Third Embodiment

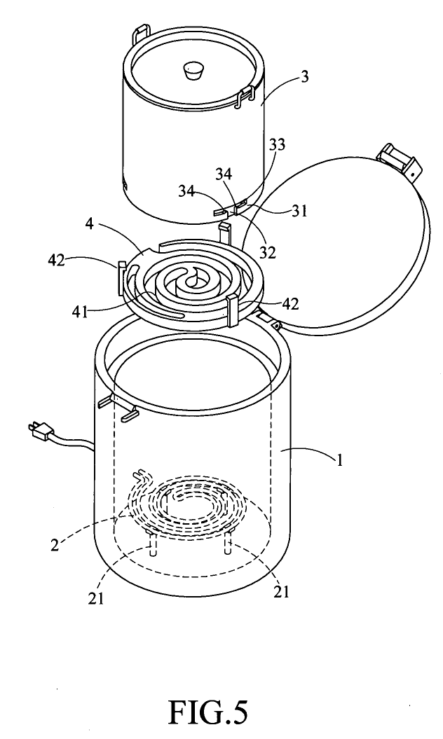

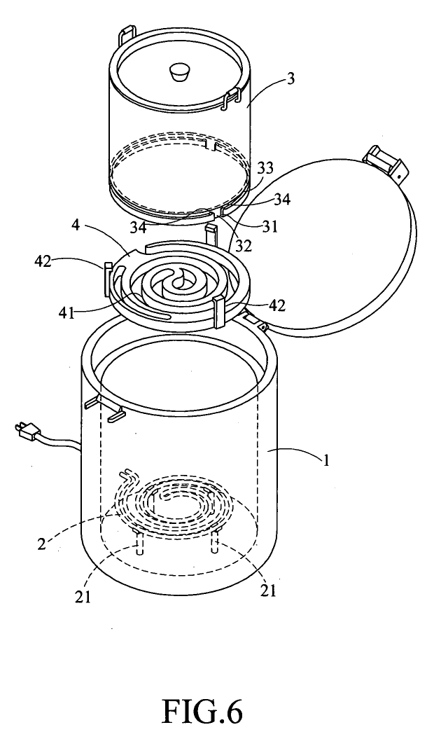

In additional, the fasteners (42) are composed of upright mounting plates (43) axially projected upward, and each of the plate (43) has a hook (44) at a distal end, the hook (44) is radial projected inward. The groove (31) is composed of a longitudinal groove (32), and a transversal groove (33) communicates with the longitudinal groove (32). The groove (31) is formed as an L-shaped groove (as shown in FIG. 3), by which movements of leading the hook (44) into the transversal groove (33) is determined only one direction. But when the groove (31) is formed as a T-shaped groove (as shown in FIG. 5), combination of movements leading the hook (44) into the transversal groove (33) is selectively determined in two different directions (i.e. either left or right). While the transversal groove (33) is formed circular in shape to surround the lateral bottom of the inner pot (3), (as shown in FIG. 6.), movements of leading the hook (44) into the transversal groove (33) is not only selectively determined in two different directions (i.e. either left or right), but also continuously gone around the transversal groove (33) until the hook (44) is led to the longitudinal groove (32) joined in the transversal groove (33), and then the hook (44) can be led out from the transversal groove (33) circular in shape.

Subsequently, as the longitudinal groove (32) joined in the transversal groove (33) at a right angle where a turn section between the longitudinal and the transversal grooves (32,33) can be shaped with projection(s) (34) projected out from a distal end(s) of the longitudinal groove (32) to prevent the hook (44) from dropping off the groove (31) in reverse direction which is opposite to the direction for movements leading the hook (44) into the transversal groove (33). Therefore, the thermal storage block (4) could not contact with the lateral bottom of the inner pot (3).

### Advantages of Embodiments of the Invention

Advantages can be achieved by embodiments of the invention as following:

1. Heating element (2) disposed above a bottom surface inside the outer pot (1) where a bottom of the inner pot (3) is already equipped with thermal storage block (4) for continuously heating up. While the inner pot (3) is positioned into the outer pot (1), the heating element (2) fit in the thermal storage block (4), is not disclosed by the prior arts.

2. Thermal storage block (4) has three fasteners (42) protruded out from a circumference are open wide enough as tripod, which disposed inside the outer pot, the inner pot (3) can be positioned on a plateau surface of the thermal storage block (4). When the heating element (2) stops heating up, the inner pot (3) still can heat food by the heated thermal storage block (4) continuously. Thereby, the inner pot (3) can be exempt from moving about an external thermal source. It is energy-saving.

3. When power out, or power electricity is unavailable for cooking, the thermal storage block (4) can be coupled to a bottom of the inner pot (3) by the fasteners (42), and then the inner pot (3) can be warmed up, for example, a gas cooker, until the thermal storage block (4) turned hot; the inner pot (3) with thermal storage block (4) can be placed into the outer pot (1) on the heating element (2) for continuously heating up the food.

4. Groove (31) is L-shaped; the hook (44) can be guided into the transversal groove (33) in only one direction. While the groove (31) is T-shaped, the hook (44) can be guided into the transversal groove (33) in two different directions. When the groove (31) is formed to surround the lateral bottom of the inner pot (3), the hook (44) can be guided into the transversal groove (33) in two different directions, and the hook (33) can be guided into the groove (33) along the transversal groove (33) circular in shape.

What is claim claimed:

1. An energy-saving cooker comprising:
an outer pot (1);
a heating element (2) disposed below a bottom of the outer pot;
an inner pot can be positioned inside the outer pot, and
a thermal storage block (4) for continuously warming up the inner pot is coupled to a bottom of the inner pot (3).
characterized in that: the thermal storage block (4) has a cut-out disk with spiral-shaped trough (41) formed through is corresponding to and fit in the heating element (2), the disk (41) further has three fasteners (42) protruded out and being projected downward and being open widely enough as a tripod disposed inside the outer pot, whereby the heating element (2) fit in the cut-out disk (41) is disposed below the bottom of inner pot, further in contact with a plateau surface of the thermal storage block (4).

2. An energy-saving cooker as claim 1 claimed wherein the thermal storage block (4) has the tripod look fasteners (42) coupled to grooves (31) at the lateral bottom of the inner pot (3), a gap is kept between the bottom of inner pot (3) and the thermal storage block (4), whereby the inner pot (3) is able to position on top of the heating element (2) of the outer pot (1).

3. An energy-saving cooker as claim 1 claimed wherein a heating element (2) consists of heating filaments can set heating time and heated temperature, after electrification turns electricity into heat, the heating element held by a tripod (21) to keep a gap to a bottom surface inside the outer pot (1).

4. An energy-saving cooker as claim 2 claimed wherein the fasteners (42) are protruded out from a circumference of the thermal storage block (4), each of the fastener (42) is equipped with an upright mounting plate (43) axially projected upward, each of the upright mounting plate (43) is further equipped with a hook (44) at a distal end, the hook is convex in shape and faces inward; the grooves (31) is composed of a longitudinal groove (32), and a transversal groove (33) in communication with the longitudinal groove (32); the hook (44) can be guided from the longitudinal groove (32) and then moved into the transversal groove (33).

5. An energy-saving cooker as claim 4 claimed wherein the groove (31) is L-shaped.

6. An energy-saving cooker as claim 4 claimed wherein the groove (31) is T-shaped.

7. An energy-saving cooker as claim 4 claimed wherein the groove (31) is circular in shape, where the transversal groove (33) surrounds the lateral bottom of the inner pot (3).

8. An energy-saving cooker as claim 4 claimed wherein a distal end of the longitudinal groove (32) joined to the transversal groove, where a projection (34) projected upward for preventing the hook (44) from being guided out in reverse direction.
